(19) United States
(12) Patent Application Publication
(10) Pub. No.: US 2026/0304320 A1
(43) Pub. Date: Oct. 1, 2026

(54) COMMUNICATION BASED ON AN ESTIMATED COMMUNICATION BUDGET

(71) Applicant: InterDigital Patent Holdings, Inc., Wilmington, DE (US)

(72) Inventors: Guanzhou Wang, Brossard (CA); Michael Starsinic, Newtown, PA (US); Michel Roy, Candiac (CA); Alec Brusilovsky, Downingtown, PA (US); Samir Ferdi, Kirkland (CA)

(73) Assignee: InterDigital Patent Holdings, Inc., Wilmington, DE (US)

(21) Appl. No.: 19/474,942

(22) PCT Filed: May 9, 2024
(86) PCT No.: PCT/US2024/028475

§ 371 Date: Oct. 13, 2025

Related U.S. Application Data
(60) Provisional application No. 63/465,647, filed on May 11, 2023.

(51) Int. Cl. H04W 52/02; H04W 4/24; H04W 68/02

(52) U.S. Cl. CPC H04W 52/0235; H04W 4/24; H04W 68/02

(57) ABSTRACT

A WTRU may send a first message to a network. The first message may include an indication of estimated communication budget information. The WTRU may receive a second message, for example from the network. The second message may be in response to the first message. The second message may include transaction information, for example associated with a data transmission. The WTRU may receive one or more of a control plane message and/or user plane data, for example associated with one or more transactions. The WTRU may determine to enter a low power state. The WTRU may send a third message, for example to the network. The third message may include an indication to continue a transaction that was not completed and/or an indication to start a transaction that was not started, for example due to an energy level associated with the WTRU.

### CROSS-REFERENCE TO RELATED APPLICATIONS

This application claims the benefit of U.S. Provisional Application No. 63/465,647 filed on May 11, 2023, the entire contents of which are incorporated herein by reference.

### BACKGROUND

An ambient power-enabled internet of things (IoT) device may be an IoT device that can harvest energy from the environment, for example one or more of wireless radio waves, motion, vibration, piezoelectricity, solar, wind power, and/or etc. An ambient power-enabled IoT device may be battery-less or may have limited energy storage (e.g., using a capacitor). Ambient power-enabled IoT devices may be used in industrial wireless senor networks, for example where the environment is harsh (e.g., extremely high or low temperature) and/or when it is desirable for devices to be battery-less, maintenance-free, and/or have a long service life. Ambient power-enabled IoT devices may also play an important role in smart logistics and/or smart warehousing. The low-cost, small-form, battery-lessness, and/or durability may make them suitable to be attached to large amounts of goods and/or facilitate more efficient goods identifying, sorting, tracking and/or inventorying.

3GPP has begun to study the potential service requirement to support ambient power-enabled IoT device in 3GPP wireless networks. Because of the extreme constraint of available energy, the ambient power-enabled IoT devices may keep their wireless transceivers working for a long time. The active time, the amount of data that can be transmitted and/or received, the communication range, etc. may be (e.g., significantly) affected by the energy constraint. Even with the aggressive power consumption saving technologies, such as long cycle discontinuous reception (DRX), there still may be challenges to perform regular activities in a wireless network.

### SUMMARY

Methods and systems are disclosed which may save power in devices. For example, an ambient power-enabled IoT device may be utilized. Alternatively, or additionally, segmented signaling procedures and systems are disclosed. A wireless transmit/receive unit (WTRU) may report an (e.g., estimated) communication budget to a network. The WTRU and network may perform a signaling procedure and/or data transmission based on the communication budget. The WTRU may choose and/or prioritize an activity, for example based on available energy and/or an (e.g., required) energy budget. The network and WTRU may perform a segmented signaling procedure, for example to ensure that a segment may be completed with the (e.g., constrained) available energy, and/or complete the (e.g., whole) procedure with multiple segments. A WTRU may be an ambient power-enabled IoT device.

A WTRU may determine communication budget information. The WTRU may send a (e.g., first) message to a network. The (e.g., first) message may include communication budget information. The message may be a radio resource control (RRC) message. The (e.g., first) message may indicate one or more of an estimated amount of downlink (DL) data, an estimated period of connection, and/or an estimated number of transactions. The WTRU may receive a (e.g., second) message, for example from the network. The (e.g., second) message may be in response to the (e.g., first) message from the WTRU to the network. The (e.g., second) message may include a threshold and/or requested transaction information. The threshold may be based on the communication budget. The WTRU may determine one or more of a duration of time that the WTRU has been in a connected mode, a number of transactions, and/or to enter a low power state, for example based on the requested transaction information. The WTRU may send a (e.g., third) message, for example to the network. The (e.g., third) message may be sent when, for example an amount of stored energy in the WTRU is greater than a threshold. The (e.g., third) message may indicate that the WTRU triggered a service request message to continue a transaction that was not completed or start a transaction that could not previously start.

The communication budget information may include one or more of an amount of data the WTRU can send or receive, an amount of time the WTRU can remain in the connected mode, and/or an amount of control plane or user plane transactions the WTRU can perform. The requested transaction information may indicate one or more of that the network triggered the WTRU to send the service request so that the network can send a control plane message to the WTRU, that the network triggered the WTRU to send the service request so that the network can send user plane data to the WTRU, an amount of data the network will send to the WTRU, an amount of time it will take to send the amount of data to the WTRU, and/or an amount of control plan or user plane transactions it will take to send the amount of data to the WTRU. Data transfer (e.g., between the WTRU and the network) may be stopped, for example when an amount of data transferred equals the threshold. The WTRU may receive a message when (e.g., after) an amount of data transferred equals the threshold. The message may include one or more of an amount of data remaining to transfer, an estimated future communication budget, and/or an estimated future communication period.

A WTRU may determine configuration information. The configuration information may include prior energy data and/or one or more parameters for adapting the configuration information. The WTRU may determine an activity energy budget, for example based on the prior energy data and/or the one or more parameters. The WTRU may determine an amount of energy required to perform one or more activities. The WTRU may determine a priority associated with one or more of (e.g., each) of the one or more activities. The WTRU may perform an activity of the one or more activities, for example based on the determined priority and/or the activity energy budget. The one or more parameters may include one or more of energy harvested by the WTRU during a period and/or energy (e.g., an amount of energy) stored by the WTRU. The priority associated with each of the one or more activities may be based on the activity energy budget and/or an available amount of energy. The available amount of energy may include one or more of energy harvested by the WTRU during a period and/or energy (e.g., an amount of energy) stored by the WTRU.

A WTRU may receive data associated with a segmented procedure. The WTRU may determine that a break-point indication has been reached, for example during the segmented procedure. The WTRU may determine to move to an idle state, for example based on the determination that the break-point has been reached. The WTRU may receive additional data associated with the segmented procedure, for example when the WTRU has harvested a predetermined amount of energy after moving to the idle state. The WTRU may receive one or more of an indication associated with the segmented procedure, an indication of the break-point, and/or an indication of whether the WTRU or the network will be a controller entity. The break-point may be associated with one or more of an amount of data transferred and/or a number of messages.

A WTRU may send a first message to a network. The first message may include an indication of estimated communication budget information. The WTRU may receive a second message, for example from the network. The second message may be in response to the first message. The second message may include transaction information, for example associated with a data transmission. The WTRU may receive one or more of a control plane message and/or user plane data, for example associated with one or more transactions. The WTRU may determine to enter a low power state. The WTRU may send a third message, for example to the network. The third message may include an indication to continue a transaction that was not completed and/or an indication to start a transaction that was not started, for example due to an energy level associated with the WTRU. The energy level may include one or more of energy harvested by the WTRU during a period or energy stored by the WTRU.

The first message may additionally, or alternatively, include an indication of a trigger. The trigger may include one or more of expiration of a timer, reception of wake-up signal, reception of a paging indication, reception of a paging message, and/or a location change. The third message may include an access network message and/or a service request message that, for example may include an indication of a transaction identifier. The WTRU may determine whether to send the third message to the network based on the transaction information and/or the energy level associated with the WTRU. The WTRU may determine to enter the low power state based on one or more of the transaction information, an amount of received data, an amount of time that the WTRU has been in a connected mode, and/or an amount of the one or more transactions.

The estimated communication budget information may include one or more of an amount of data associated with the data transmission, an amount of time the WTRU can stay in a connected mode, and/or an amount of the one or more transactions. The transaction information associated with a data transmission may include one or more of a reason that the network triggered the WTRU to send the service request, an amount of data associated with the data transmission, an amount of time associated with the data transmission, and/or an amount of the one or more transactions. The WTRU may determine the estimated communication budget information. The communication budget information may include (e.g., an indication of) an energy level of a WTRU, for example an available energy level.

A WTRU may determine an available energy level of the WTRU. The WTRU may determine a first amount of energy that, for example may be required to perform a first activity and/or a second amount of energy that, for example may be required to perform a second activity. The WTRU may compare the first amount of energy and/or the second amount of energy to the available energy level of the WTRU. The WTRU may determine whether to perform one or more of the first activity and/or the second activity, for example based on the comparison.

The first activity and/or the second activity may include one or more of performing a signal measurement, performing cell selection, reading system information, monitoring a channel, sending a message or data packet, and/or performing a registration update. The WTRU may determine one or more of the first amount of energy (e.g., that may be required to perform the first activity) and/or the second amount of energy (e.g., that may be required to perform the second activity) based on an amount of active time required for the respective activity.

The WTRU may determine a first priority level associated with the first activity and/or a second priority level associated with the second activity. The WTRU may compare the first priority level associated with the first activity to the second priority level associated with the second activity. The WTRU may determine to perform the first activity, for example when the first priority level associated with the first activity is higher than the second priority level associated with the second activity. The WTRU may determine whether to perform the second activity based on comparing the second amount of energy (e.g., that may be required to perform the second activity) to a remaining available energy level of the WTRU. The remaining available energy level of the WTRU may include remaining available energy after performing the first activity.

The first priority level associated with the first activity may include an explicit priority level and/or the second priority level associated with the second activity may not include an explicit priority level. The WTRU may determine to perform the first activity, for example when the first priority level associated with the first activity includes an explicit priority level and/or the second priority level associated with the second activity does not include an explicit priority level. The WTRU may determine to enter a low power state, for example if the remaining available energy level of the WTRU is less than one or more of the first amount of energy required to perform the first activity and/or the second amount of energy required to perform the second activity. The WTRU may perform the first activity and/or the second activity based on the available energy level of the WTRU, the first amount of energy, and/or the second amount of energy.

A WTRU and/or a network entity may determine that a segmented procedure will be performed, for example based on an indication of a break point. The WTRU and/or a network entity may receive first data associated with the segmented procedure. The WTRU and/or a network entity may determine that the break point has been reached. The WTRU may determine to enter an idle state, for example based on the determination that the break point has been reached. The WTRU and/or a network entity may determine to continue the segmented procedure, for example based on an amount of energy harvested by the WTRU in the idle state. The WTRU and/or a network entity may receive second data associated with the segmented procedure.

The WTRU and/or a network entity may receive the indication of the break point, for example from a network entity and/or WTRU. The WTRU and/or a network entity may send a break point indication to a network and/or a network entity, for example when the WTRU and/or a network entity has determined that the break point has been reached. The WTRU and/or a network entity may determine to send the break point indication, for example after receiving an amount of data or is determined after receiving a number of messages.

The indication of the break point may include one or more of a message identifier, a number of messages, and/or an amount of data. The indication of the break point may additionally, or alternatively, include one or more of an indication of whether the WTRU and/or a network entity will be (e.g., is) a controller entity in the segmented procedure. The WTRU and/or a network entity may determine to continue the segmented procedure, for example when the amount of energy harvested by the WTRU in the idle state is greater than a predetermined threshold.

A network entity may determine that a segmented procedure will be performed with a WTRU, for example based on an indication of a break point. The network entity may send first data. The first data may be associated with the segmented procedure. The network entity may determine that the WTRU is in an idle state, for example based on the indication of the break point. The network entity may send second data associated with the segmented procedure.

The network entity may receive the indication of the break point, for example from the WTRU. The network entity may receive a break point indication from the WTRU, for example that indicates that the break point has been reached. The indication of the break point may include one or more of a message identifier, a number of messages, and/or an amount of data. The network entity may receive an indication of a current communication budget of the WTRU. The current communication budget of the WTRU may indicate an available amount of energy in the WTRU.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is an example procedure of a WTRU-Network communication based on estimated communication budget.

FIG. 3 is an example procedure associated with a communication budget.

FIG. 4 is an example of a segmented signaling procedure.

### DETAILED DESCRIPTION

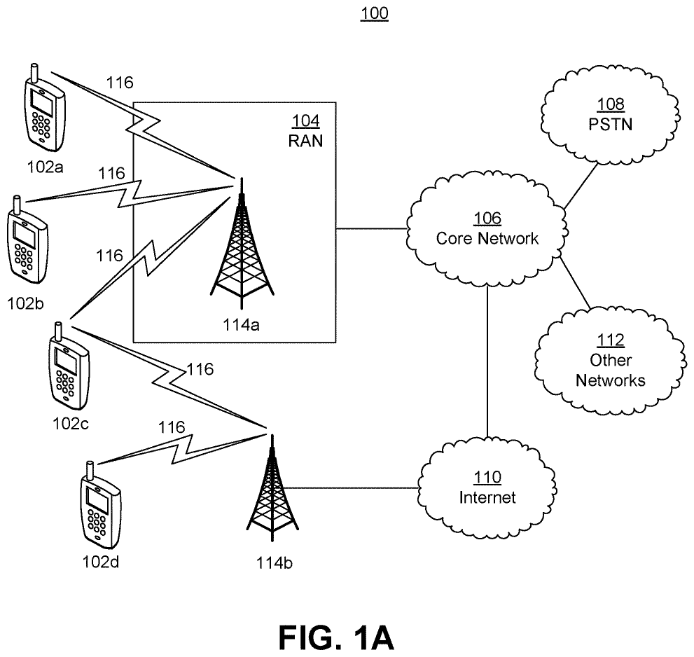

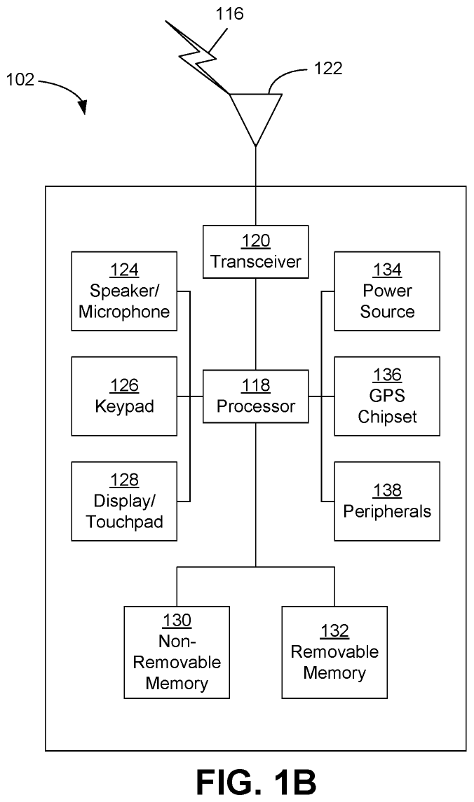

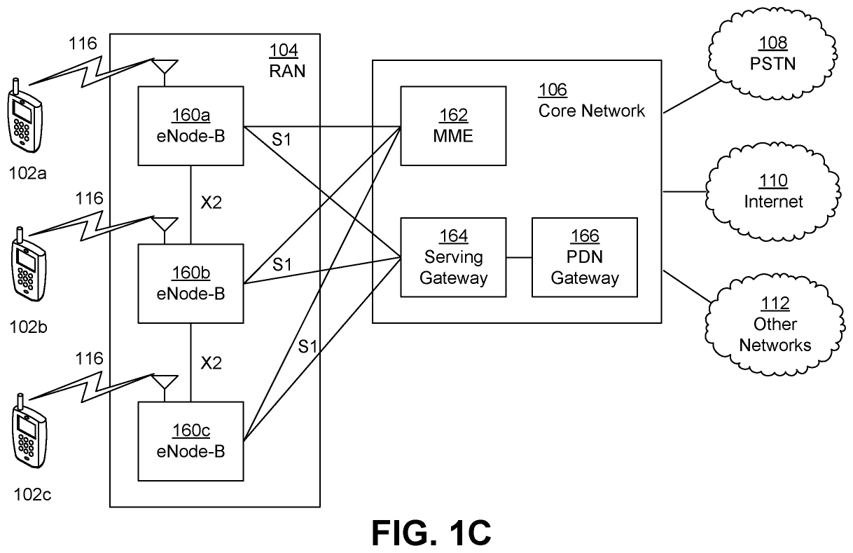

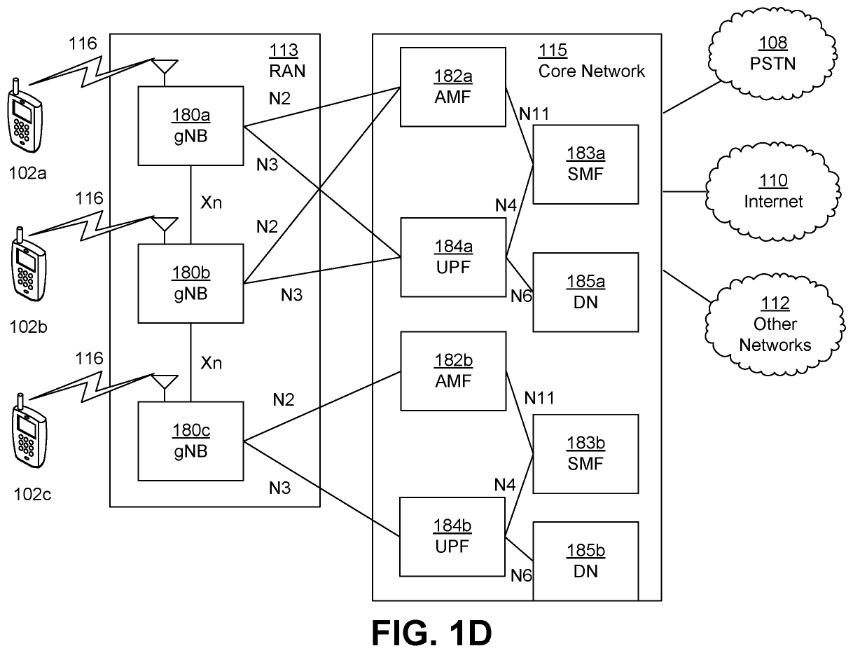

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUS 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114 b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116,

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment, The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAS that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHZ channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11 ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTls) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Methods and systems are disclosed which may save power in devices. For example, an ambient power-enabled IoT device may be utilized. Alternatively, or additionally, segmented signaling procedures and systems are disclosed. A wireless transmit/receive unit (WTRU) may report an (e.g., estimated) communication budget to a network. The WTRU and network may perform a signaling procedure and/or data transmission based on the communication budget. The WTRU may choose and/or prioritize an activity, for example based on available energy and/or a (e.g., required) energy budget. The network and WTRU may perform a segmented signaling procedure, for example to ensure that a segment may be completed with the (e.g., constrained) available energy, and/or complete the (e.g., whole) procedure with multiple segments.

A WTRU may determine communication budget information. The WTRU may send a (e.g., first) message to a network. The (e.g., first) message may include communication budget information. The message may be a radio resource control (RRC) message. The (e.g., first) message may indicate one or more of an estimated amount of downlink (DL) data, an estimated period of connection, and/or an estimated number of transactions. The WTRU may receive a (e.g., second) message, for example from the network. The (e.g., second) message may be in response to the (e.g., first) message from the WTRU to the network. The (e.g., second) message may include a threshold and/or requested transaction information. The threshold may be based on the communication budget. The WTRU may determine one or more of a duration of time that the WTRU has been in a connected mode, a number of transactions, and/or to enter a low power state, for example based on the requested transaction information. The WTRU may send a (e.g., third) message, for example to the network. The (e.g., third) message may be sent when, for example an amount of stored energy in the WTRU is greater than a threshold. The (e.g., third) message may indicate that the WTRU triggered a service request message to continue a transaction that was not completed and/or start a transaction that could not previously start.

The communication budget information may include one or more of an amount of data the WTRU can send or receive, an amount of time the WTRU can remain in the connected mode, and/or an amount of control plane or user plane transactions the WTRU can perform. The requested transaction information may indicate that the network triggered the WTRU to send the service request so that the network can send a control plane message to the WTRU. Additionally, or alternatively the requested transaction information may indicate that the network triggered the WTRU to send the service request so that the network can send user plane data to the WTRU. Additionally, or alternatively the requested transaction information may indicate one or more of an amount of data the network will send to the WTRU, an amount of time it will take to send the amount of data to the WTRU, and/or an amount of control plan or user plane transactions it will take to send the amount of data to the WTRU. Data transfer (e.g., between the WTRU and the network) may be stopped, for example when an amount of data transferred equals the threshold. The WTRU may send a message (e.g., to the network) when (e.g., after) an amount of data transferred equals and/or exceeds the threshold. The message may include one or more of an amount of data remaining to transfer, an estimated future communication budget, and/or an estimated future communication period.

A WTRU may determine configuration information. The configuration information may include prior energy data and/or one or more parameters for adapting the configuration information. The WTRU may determine an activity energy budget, for example based on the prior energy data and/or the one or more parameters. The WTRU may determine an amount of energy required to perform one or more activities. The WTRU may determine a priority associated with one or more of (e.g., each) of the one or more activities. The WTRU may perform an activity of the one or more activities, for example based on the determined priority and/or the activity energy budget. The one or more parameters may include one or more of energy harvested by the WTRU during a period or energy stored by the WTRU. The priority associated with each of the one or more activities may be based on the activity energy budget and/or an available amount of energy. The available amount of energy may include one or more of energy harvested by the WTRU during a period and/or energy stored by the WTRU. The energy level may include one or more of energy harvested by the WTRU during a period or energy stored by the WTRU.

A WTRU may receive data associated with a segmented procedure. The WTRU may determine that a break point indication has been reached, for example during the segmented procedure. The WTRU may determine to move to an idle state, for example based on the determination that the break point has been reached. The WTRU may receive additional data associated with the segmented procedure, for example when the WTRU has harvested a predetermined amount of energy after moving to the idle state. The WTRU may receive one or more of an indication associated with the segmented procedure, an indication of the break point, and/or an indication of whether the WTRU or the network will be a controller entity. The break point may be associated with one or more of an amount of data transferred and/or a number of messages.

For some wireless devices, for example ambient-powered IoT devices, the availability, reachability, and/or active time may not be predictable in the (e.g., core) network. This may be at least partly due to there being no or (e.g., very) limited stored energy in ambient power-enabled IoT devices. The devices may remain inactive and/or dormant for a long and/or unpredictable period of time. Alternatively, or additionally, there may be no periodical duty cycle (e.g., DRX) that may be known and/or calculated in the network. This unpredictability of device availability may pose a challenge to a variety of existing system procedures. For example, the paging mechanism, which may rely on the agreed DRX cycle and/or paging occasions between the WTRU and the network, may not work for these devices. For example, these devices may not be able to sustain normal DRX operation (e.g., even with a very long DRX cycle).

The unpredictability of device availability may affect the WTRU idle mode operations and challenge the active communication between the device and the network. When such devices have harvested enough energy to initiate a communication task and/or establish the connection with the network for example, these devices may be able (e.g., only able) to sustain the active time for a very short period of time, and/or send/receive a very small amount of data. The active time or the amount of data that the device is able to sustain may be referred to as communication budget herein. The active time and/or the amount of data that the device may (e.g., is able to) sustain may depend on one or more factors. The one or more factors may include one or more of whether the WTRU is able to store the energy and/or has the capacity of the storage.

Additionally, or alternatively, the one or more factors may include the speed of the device's energy harvesting and/or the ambient energy density, etc. Additionally, or alternatively, the one or more factors may include active time or the amount of data that the device is able to sustain is not known or predictable to the network. This may cause a problem. For example, a system procedure (e.g., registration and/or PDU session establishment) may take a longer time than that supported by the device, and/or may be (e.g., have to be) aborted (e.g., abruptly), for example when the device runs out of power. The network may have a relatively larger amount of downlink data in the buffer and/or may send the larger amount of downlink data in the buffer (e.g., all of the downlink data in the buffer), for example without knowing that the WTRU may be able (e.g., only able) to receive a part of the downlink data,

Devices and methods are disclosed herein to address issues. For example, issues are addressed herein to enable the network to ascertain the device availability and/or communication budget and/or to enable system procedures when the device communication budget does not support what these procedures usually require.

A WTRU-Network communication may be based on a WTRU estimated communication budget. There may be a communication based on estimated communication budget. A WTRU may send a message to a network. The message may include communication budget information. For example, the communication budget information may be estimated communication budget information. The communication budget information may indicate one or more of how much data the WTRU anticipates the WTRU can send/receive, how much time the WTRU anticipates the WTRU can stay in a mode where the WTRU is connected to the network and send/receive data, and/or how many control plane and/or user plane transactions the WTRU anticipates the WTRU can perform.

The message may indicate an event that triggered the WTRU to send the message. The event may be one or more of an expiration of a timer, reception of wake-up signal, reception of a paging indication, reception of a paging message, entering a location, and/or leaving a location. The message may indicate the amount of uplink (UL) data in a WTRU buffer. The message may be a non-access stratum (NAS) request (e.g., registration request and/or service request) message. The message may be an access network message (e.g., RRC message).

The WTRU may receive a response message from the network. The response message may include requested transaction information. The requested transaction information may indicate that the reason that the network triggered the WTRU to send the service request is so that the network can send a control plane (CP) message (e.g., a NAS message) to the WTRU. Additionally, or alternatively, the requested transaction information may indicate one or more of that the reason that the network triggered the WTRU to send the service request is so that the network can send user plane data to the WTRU, how much data the network anticipates the network will send to the WTRU, how much time the network anticipates take to send the data to the WTRU, and/or how many control plane or user plane transactions the network anticipates it will take to send the data to the WTRU.

The response message may additionally, or alternatively indicate to the WTRU if the data (e.g., all of the data) may be sent in a single power cycle or if the data may be sent in multiple power cycles. The requested transaction information may indicate one or more of how much data, how much time, and/or how many transactions are required to in the current power cycle, in total, and/or in future power cycles. The response message may indicate to the WTRU that the WTRU does not have sufficient power (e.g., communication budget) to begin receiving the data. The response message may indicate that the WTRU should therefore (e.g., immediately) return to the low power and/or sleep state. The WTRU may determine to return to the low power and/or sleep state. The response message may include a transaction ID. The response message may be a service accept message.

Control plane messages and/or user plane data may be received. For example, control plane messages and/or user plane data may be received by the WTRU and/or the network (e.g., AMF). The WTRU and/or the network may determine to enter a low power state, for example based on the requested transaction information. Additionally, or alternatively, the WTRU and/or the network may determine one or more of the amount of received data, the duration of time that the WTRU has been in a connected mode, and/or a number of transactions. The WTRU may determine, for example based on the requested transaction information and an amount of stored energy, to send a second message to the network. The WTRU may send the second message to the network. The second message may indicate that the WTRU triggered the service request message, for example because the WTRU may determine to continue a transaction that was not completed and/or start a transaction that could not previously start because the WTRU previously did not have enough energy stored. The message may include a transaction ID. The message may be a service request message. The message may be an access network message.

The WTRU may calculate and/or infer the communication budget for the upcoming communication session, and/or inform the (e.g., core) network. The core network may determine one or more activities that may be supported by the WTRU communication budget for the ongoing session, (e.g., the amount of data or signaling that can be exchanged). A communication session and/or a communication window herein may refer to the period between the time when the WTRU and/or network initiates the communication and the time that the WTRU has to stop communication, for example because the WTRU runs out of energy. During (e.g., such) a communication session for example, the WTRU and/or network may perform one or more signaling procedures. Example signaling procedures may include one or more of registration and protocol data unit (PDU) Session establishment, and/or UL/DL data transmissions/receptions.

The WTRU may calculate the communication budget according to the WTRU harvested and/or stored energy level, and/or the information on the amount of energy consumed by a unit of active time (e.g., a second or millisecond) or data (e.g., a bit or byte). Information may be pre-configured in the WTRU and/or may be (e.g., empirically) calculated, inferred, and/or estimated (e.g., by the WTRU). The calculated communication budget may include the active time and/or amount of data transmission that the WTRU can sustain. A calculation and/or inference discussed herein may consume energy. The energy consumption may be considered/accounted for in any calculation and/or inference.

The WTRU may calculate the communication budget prior to the WTRU connection with the network, for example for a communication session (e.g., signaling or data transmission). The WTRU may inform the network of the calculated communication budget. The communication budget may be expressed in terms of the active time and/or the amount of data transmission/reception operations that the WTRU available energy may sustain, for example when the WTRU connects with the network. If the WTRU is connecting/connected (e.g., getting connected) with the network for UL data transmission for example, the WTRU may additionally, or alternatively, report the amount of UL data to be transmitted.

The WTRU may indicate in a message that the WTRU is a power-constrained device and/or the calculated communication budget for the ongoing session. For example if the WTRU performs a registration update and/or service request with the network, the WTRU may indicate in the registration request and/or service request message that the WTRU is a power-constrained device and/or the calculated communication budget for the ongoing session. The WTRU may additionally, or alternatively, indicate a maximum communication budget. A maximum communication budget that the WTRU would indicate which may be based on the WTRU energy storage being full.

The WTRU may additionally, or alternatively, calculate/estimate a future communication window and/or budget. The WTRU may report the future communication window and/or budget to the network. The WTRU may report, for example to the network, one or more of the next available communication time window after the ongoing communication session, and/or the estimated communication budget. The WTRU may estimate the next available communication time window, for example based on one or more factors. The one or more factors may include the ambient energy density, the speed of WTRU energy harvesting, the capacity of WTRU energy storage, and/or etc. The WTRU may include multiple future communication time windows. The estimated communication budget may be for one or more (e.g., each) future communication window.

The WTRU may send the information regarding the future communication windows together with the estimated communication budget for the ongoing session at the same time (e.g., in the same registration request and/or service request message). Additionally, or alternatively, the WTRU may send the information at a later time (e.g., before it aborts the ongoing communication session).

For example according to the received communication budget, the network may determine one or more of how much downlink data the network is going to deliver to WTRU in the current session and/or whether the ongoing signaling procedure can be completed in the current session. The network may determine whether to break down the procedure into several consecutive segments, for example if the network determines whether the ongoing signaling procedure can be completed in the current session (e.g., based on the communication budget). If the network has more data in the downlink buffer than what the WTRU indicates in the communication budget information that the WTRU is able to handle for example, the network may choose to send the amount of downlink data that is within the WTRU-estimated communication budget and/or determine to buffer the data (e.g., until a better communication budget estimate is received from the WTRU). If the network decides to break down the procedure for example, the network may perform one segment (e.g., only one segment) of the procedure that the WTRU is able to complete during the current session and/or continue with the other segments of the procedure in future communication sessions. Systems and methods for signaling segmenting are described herein.

The network may return (e.g., send) information to the WTRU, for example based on the determination. The information may include the maximum amount of DL data that the network has determined to deliver using the current session and/or the maximum amount of UL data that the WTRU is supposed to send using the current session. Additionally, or alternatively, the information may include an indication of whether the network has decided to break down the ongoing signaling procedure into several consecutive segments and/or an indication of whether the WTRU should inform the network before the network and/or the WTRU aborts the communication and returns to dormant or inactive state. Additionally, or alternatively, the information may include a future time window that the network expects to resume the communication with the WTRU. The WTRU may count the amount of received DL data, and/or determine when the data (e.g., received DL data) has reached the network-indicated amount.

Additionally, or alternatively, the WTRU may abort the communication session and/or go (e.g., back) to dormant and/or inactive state. The WTRU may count (e.g., determine) the amount of received UL data, and/or when determine when the data (e.g., received UL data) has reached the network-indicated amount. Additionally, or alternatively, the WTRU may abort the communication session and/or go (e.g., back) to dormant and/or inactive state.

Alternatively, or additionally, the WTRU may report (e.g., only report) the WTRU available energy level. The network may calculate and/or estimate the active time and/or amount of data that the WTRU may support with the reported energy level. The network may return the estimated communication budget information and/or other additional information, for example as described herein, to the WTRU. The network may utilize intelligent analytics (e.g., provided by NWDAF), for example to help determine the above communication budget information.

The estimated communication budget information may include one or more of an amount of data associated with the data transmission, an amount of time the WTRU can stay in a connected mode, and/or an amount of the one or more transactions. The transaction information associated with a data transmission may include one or more of a reason that the network triggered the WTRU to send the service request, an amount of data associated with the data transmission, an amount of time associated with the data transmission, and/or an amount of the one or more transactions. The WTRU may determine the estimated communication budget information. The communication budget information may include (e.g., an indication of) an energy level of a WTRU, for example an available energy level.

Alternatively, or additionally, the WTRU and the network may be (e.g., both) configured with a power budget map (PBM). The PBM may include a table. The PBM may list one or more of (e.g., various) energy levels, ranges, and/or the WTRUs corresponding communication budget. The WTRU may indicate to the network the index to the entry in the table that corresponds to the WTRU current energy level. The network may determine the WTRU current energy level, for example from the indication of the entry in the table. The WTRU may not (e.g., may not need to) perform a calculation in the WTRU (e.g., to determine energy level). The WTRU may (e.g., therefore) send less information to the network and/or (e.g., therefore) reduce power consumption.

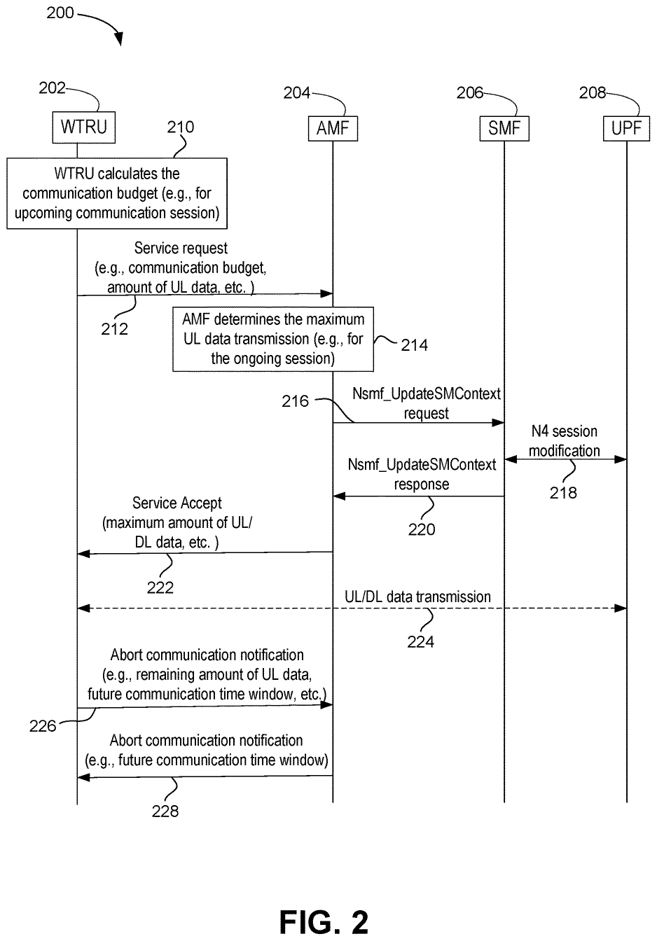

FIG. 2 is an example of a WTRU-Network communication procedure 200 based on an estimated communication budget. At 210, the WTRU 202 may determine (e.g., estimate) a communication budget, for example, for an upcoming communication session. For example, the WTRU 202 may determine, at 210, that the WTRU has harvested enough energy for an UL data transmission. The WTRU 202 may estimate the communication budget, for example based on the harvested/stored energy level of the WTRU 202. Additionally, or alternatively, the WTRU 202 may estimate the communication budget before the WTRU initiates a service request for UL data transmission. At 212, the WTRU 202 may initiate a service request procedure, for example for UL data transmission. For example, the WTRU 202 may send, at 212, a service request message to the network (e.g., AMF 204). In the service request message for example, the WTRU 202 may inform the network of the WTRU estimated communication budget for the ongoing communication session, and/or the amount of UL data that is in the WTRU buffer. At 214, the serving AMF 204 may process the service request. The AMF 204 may determine, at 214, a maximum amount of UL data that the WTRU 202 should send, for example, during the ongoing session. The determination, at 214, may additionally, or alternatively, be made after 220. Alternatively, or additionally, the AMF 204 may forward the WTRU estimated communication budget to the SMF 206, for example in 216, and/or the SMF 206 may determine the maximum amount of UL data that the WTRU 202 should send.

At 216, 218, and/or 220, the AMF 204 may invoke the SMF 206 service to activate the user plane for the PDU session for data transmission. If for example the SMF 206 makes the determination of the maximum UL/DL data to be transmitted, the SMF 206 may inform the AMF 204 of the result, for example at 220. At 222, the AMF 204 may send a service accept message to the WTRU 202. The service accept message may include the network-determined maximum UL/DL data to be transmitted during the ongoing session. At 224, the WTRU 202 and the network may start an UL data transmission and/or a DL data transmission. The WTRU 202 may determine (e.g., count) the amount of UL/DL data that has been sent and/or received. At 226, the WTRU 202 may stop the data transmission/reception, for example, when the amount of UL/DL data that has been sent and/or received reaches the network-indicated maximum amount of UL/DL data,. The WTRU 202 may send, at 226, an abort communication notification to the network. The abort communication notification may include a report of the amount of remaining UL data, and/or an estimate of future communication windows and/or communication budgets. The WTRU 202 may alternatively, or additionally, send the notification if the WTRU 202 and/or the network determines that the remaining energy will not support any further data transmission. At 228, the AMF 204 may invoke the SMF 206 service to put the related PDU Session on hold, for example, when the AMF 204 learns (e.g., determines) that the WTRU 202 is going to (e.g., has determined to) abort the communication,.

The WTRU 202 and/or the network (e.g., the AMF 204) may additionally, or alternatively, determine an appropriate future communication time, for example based on WTRU-estimated future communication window and/or communication budget. The network (e.g., the AMF 204) may return the determined future communication time and/or time window to the WTRU 202. The WTRU 202 may determine to (e.g., try to) initiate another connection with the network, for example at the determined future time. After 228 for example, the WTRU 202 may shutdown the wireless transceiver and/or go to the dormant/inactive mode, and/or continue to harvest the ambient energy.

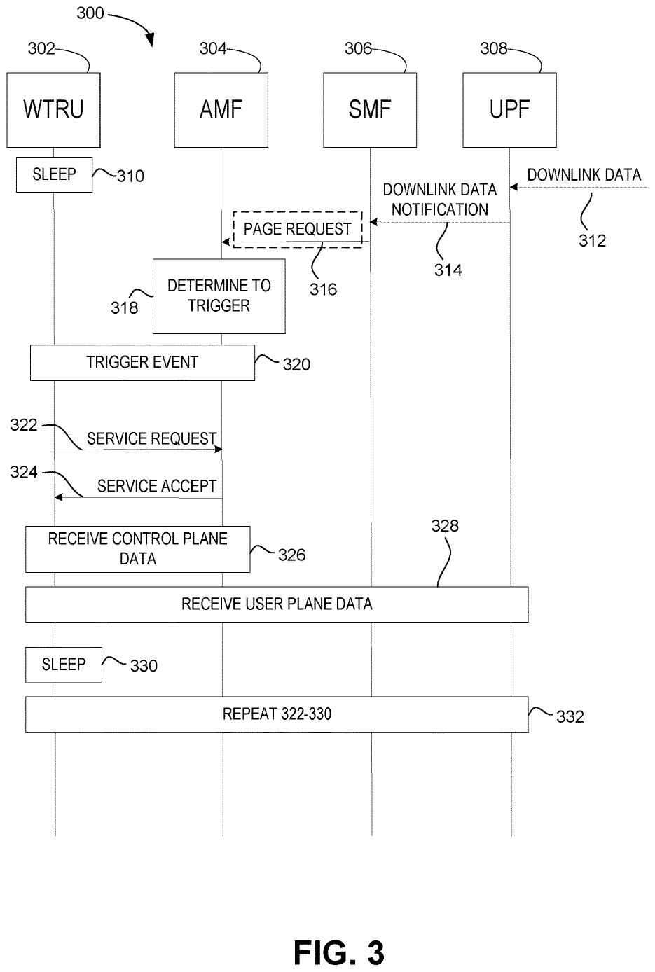

A Communication Budget may be applied to MT Data. FIG. 3 is an example procedure 300 associated with a communication budget. The procedure 300 shows an example of how a WTRU 302 and a network may negotiate how much data can be sent to the WTRU 302, for example before the WTRU 302 enters a low power state. The procedure 300 also shows an example of how a WTRU 302 and a network may negotiate to divide a data transfer, for example across one or more WTRU low power to connected mode state transitions. At 310, the WTRU 302 may be in a sleep and/or low power state. The WTRU 302 may harvest energy during this time (e.g., while in the sleep and/or low power state) and/or store the energy in a battery and/or capacitor.

At 312, the UPF 308 may receive downlink data. At 314, the UPF 308 may send a downlink data notification to the SMF 306. The SMF 306 may, for example at 316, send a page request to an AMF 304, after receiving the downlink data notification from the UPF 308. The AMF 304 may receive, at 316, the page request from the SMF 306 to page the WTRU 302. At 318, the AMF 304 may determine to trigger the WTRU 302 to send a service request to the network. The AMF 304 may determine, at 318, to trigger the WTRU 302 to send a service request, for example, based on receipt of the page request from the SMF 306 to page the WTRU 302 and/or because the AMF 304 has determined to send control plane information to the WTRU 302. The AMF 304 may trigger the WTRU 302 by requesting that a RAN Node page the WTRU 302 and/or send a wake-up signal to the WTRU 302.

At 320, a triggering event may be detected by the WTRU 302. The triggering event may cause (e.g., trigger) the WTRU 302 to determine to send a service request message to the network. Examples of triggering events may include expiration of a timer in the WTRU, detection of uplink data from an application that is hosted in the WTRU, detection of a wake up signal, detection of an energy burst, detection of a paging indication, detection of a paging message, and/or detection of a location change. At 322, the WTRU 302 may send a service request message to the network (e.g., the AMF 304). The service request message may be carried in an access network (AN) message. For example, the AN message may be an RRC message. The AN message and/or the service request message (e.g., which may be included inside of the AN message) may include communication budget information. Communication budget information may indicate one or more of an amount of data the WTRU 302 anticipates the WTRU 302 may receive, an amount of time the WTRU 302 anticipates the WTRU 302 may stay in a mode where the WTRU 302 is connected to the network and/or receiving data; and/or how many control plane and/or user plane transactions the WTRU 302 anticipates the WTRU 302 can perform.

AN message and/or the service request message (e.g., which may be included inside of the AN message) may additionally, or alternatively, include an indication of the event that triggered the WTRU 302 to send the service request message (e.g., expiration of a timer, reception of wake-up signal, reception of an energy burst, reception of a paging indication, reception of a paging message, entering a location, and/or leaving a location).

As described herein, the WTRU 302 may determine the communication budget information based on an amount energy the WTRU 302 has stored in a battery and/or capacitor. A control plane transaction may include the WTRU 302 receiving a message from the network and/or sending a response. A user plane transaction may include the WTRU 302 receiving a block of user plane data from the network and/or the WTRU 302 sending an acknowledgement. For example if the communication budget information is sent to the network in the AN message and/or outside of the service request message, (e.g., then) the RAN node may forward the communication budget information to the AMF 304. One advantage of sending the communication budget information in the AN message and/or outside of the service request message may include visibility to the RAN node. The RAN node may consider the information, for example in a scheduling algorithm.

At 324, the AMF 304 may send a service accept message to the WTRU 302, for example, in response to the service request message. The service accept message may be carried to the WTRU 302 in an AN message. The service accept message (e.g., which may be included inside of the AN message) may include requested transaction information.

The requested transaction information may indicate a reason that the network triggered the WTRU 302 to send the service request, for example so that the network may send a control plane message (e.g., a NAS message) to the WTRU 302 and/or so that the network can send user plane data to the WTRU 302. Additionally, or alternatively, the requested transaction information may indicate one or more of an amount of data the network anticipates the network will send to the WTRU 302, an amount of time the network anticipates take to send the data to the WTRU 302, and/or how many control plane and/or user plane transactions the network anticipates it will take to send the data to the WTRU 302.

The service accept message may carry the control plane information. Additionally, or alternatively, the network may send the control plane information in a (e.g., subsequent) message. For example, when the indicated reason is that the network triggered the WTRU 302 to send the service request was so that the network can send a control plane message (e.g., a NAS message) to the WTRU 302, the service accept message may carry the control plane information and/or the network may send the control plane information in a subsequent message. The service accept message may indicate if a follow-up message will be sent. The service accept message may alternatively, or additionally, indicate to the WTRU 302 if the data (e.g., all of the data) can be sent in a single power cycle or if the data will be sent in multiple power cycles. The requested transaction information may indicate one or more of an amount of data, an amount of time, and/or an amount of transactions that may be in the current power cycle, in total, and/or in future power cycles.

The service accept message may indicate to the WTRU 302 that the WTRU 302 does not have sufficient power (e.g., communication budget) to begin receiving the data and/or should (e.g., immediately) return to the low power and/or sleep state. The indication may be sent in a service reject message, for example with the requested transaction information. When this message is sent to the WTRU 302 for example, the procedure 300 may proceed to 330. The WTRU 302 may (e.g., then) trigger a (e.g., new) service request message, for example when the WTRU 302 determines that the WTRU 302 has enough energy to perform (e.g., continue) the procedure 300. The WTRU 302 may determine whether the WTRU 302 has enough energy to perform (e.g., continue) the procedure 300 based, at least in part, on the requested transaction information. The requested transaction information may be associated with and/or include a transaction ID.

The WTRU 302 may receive the data (e.g., all of the data) before powering down, for example if the data is sent in a single power cycle. The WTRU 302 may receive some of the data before powering down and harvesting more energy, for example if the data is sent in multiple power cycles. The WTRU 302 may (e.g., later) wake up and/or receive the rest of the data, for example by initiating a second service request message. The requested transaction information may be (e.g., may have been) determined by the AMF 304, for example at 318. For example, the AMF 304 may determine the requested transaction information based on one or more of the type of control plane message(s) to be sent to the WTRU 302, and/or information that was received from the SMF 306, for example at 314 (e.g., about the amount of user plane data to be sent to the WTRU 302).

At 326, the WTRU 302 may (e.g., begin to) receive control plane messages (e.g., NAS messages), for example from the AMF 304. Additionally, or alternatively, for example at 328, the WTRU may (e.g., begin to) receive user plane data from the network. At 326, the AMF 304 may coordinate the sending of control plane messages to the WTRU 302, for example by counting the number of messages that are sent and/or determining to stop the transmissions to the WTRU based on the requested transaction information.

At 328, the AMF 304 may coordinate the sending of user plane data to the WTRU 302, for example by indicating to the SMF 306 how much data may be sent and/or how long the SMF 306 may take to send the data. The SMF 306 may (e.g., then) determine to stop the transmissions to the WTRU 302, for example based on the information from the SMF 306. The AMF 304 may use the requested transaction information to determine what information to indicate to the SMF 306. The WTRU 302 may trigger a return to a sleep and/or low power state, and/or begin harvesting energy, for example when the WTRU 302 determines that the power cycle is complete. The WTRU 302 may use the requested transaction information, for example that was received at 324, to determine when the power cycle is complete. The WTRU 302 may return to the sleep and/or low power state when the number of transactions performed, the amount of data, and/or the duration of connected time matches the one or more values that were indicted in the requested transaction information.

At 330, the WTRU 302 may be in a low power and/or sleep state. If the transaction was completed in a single power cycle for example, (e.g., then) the flow (e.g., the procedure 300) may stop here. The WTRU 302 may return to 310 and/or wait for the next trigger event. If the transaction was completed in a single power cycle and/or the network indicated to the WTRU 302 that the WTRU 302 does not have sufficient power (e.g., communication budget) to begin receiving the data (e.g., and/or should therefore immediately return to the low power and/or sleep state), then the WTRU 302 may remain in the same state and/or harvest energy. For example, the WTRU 302 may harvest energy until the WTRU 302 determines that the WTRU 302 has enough power to perform the next operation. The WTRU 302 may remain in the same state until the WTRU 302 has enough energy stored to receive the amount of data that was indicated in the requested transaction information and/or until the WTRU 302 has enough energy stored to stay connected for the duration that was indicated in the requested transaction information.

At 332, the WTRU 302 may send a second service request message, for example to repeat one or more of steps 322 through 330. The service request message may be as described herein, for example at 322. The service request message may additionally, or alternatively, include an indication that the WTRU 302 triggered the service request message because the WTRU 302 determined (e.g., wishes) to continue a transaction that was not completed and/or start a transaction that could not previously start, for example because the WTRU 302 previously did not have enough energy stored. The service request message may include a transaction ID (e.g., that was received), for example at 324.

A WTRU may perform (e.g., autonomous) activity selection, for example based on a communication budget. The WTRU may be preconfigured with and/or may determine (e.g., derive from empirical usage) a configuration that indicates a communication budget (e.g., active time, amount of data, amount of energy) for an activity. The WTRU may estimate the required communication budget to perform one and/or multiple activities. Based on the available energy and/or the estimation of required communication budget, the WTRU may execute a strategy to select and/or prioritize an activity to perform.

For example when the WTRU has harvested and/or stored a certain amount (e.g., a predetermined amount) of energy and/or decides to perform some activity, the WTRU may have multiple activities that are due at the same time. For example, the WTRU may perform wireless signal measurement and/or perform cell selection/reselection. Additionally, or alternatively the WTRU may perform one or more of reading and/or updating broadcasted system information, monitoring a paging channel to check if the WTRU is being paged by the network for DL data delivery, responding to a paging, performing a registration update procedure. Additionally, or alternatively, the WTRU may have UL data in the buffer and/or initiate a service request procedure to transmit the data.

The available energy in the WTRU may not be sufficient (e.g., able) to support completing multiple activities and/or even one activity, for example that requires more energy. If the WTRU chooses an activity (e.g., the wrong activity) to perform for example which may require more energy or activity than what the WTRU can support, the WTRU may not be able to complete the activity and/or end up wasting energy and/or a communication opportunity.

The WTRU may be preconfigured or derive (e.g., from the WTRU's own empirical experience) one or more of a typical/average amount of energy, an active time, a data transmission that typical activities and/or procedures require, and/or an amount of energy required for a unit of active time or data. Additionally, or alternatively, a configuration may include one or more of a cell measurement/reselection procedure, a service request procedure, an indication that D μ-Joule energy is required for one millisecond of active time, an indication that E μ-Joule energy is required for one byte of data transmission/reception, and/or etc. A cell measurement/reselection procedure may include a requirement of A milliseconds of active time and no data transmission. A service request procedure may include a requirement of B milliseconds of active time and/or C Bytes of control plane messages. A, B, C, D, E, and/or etc. may be any number.

Additionally, or alternatively, the WTRU may be preconfigured or derive (e.g., from the WTRU's own empirical experience) one or more parameters for adapting the configuration according to the current wireless signal quality. For example with a lower reference signal received power (RSRP)/reference signal received quality (RSRQ), it might require more energy to transmit the same amount of data than that is required with a higher RSRP/RSRQ. A configuration herein may be adapted (e.g., multiplied by a ratio that reflects the wireless signal quality). Additionally, or alternatively, the WTRU may be preconfigured or derive (e.g., from its own empirical experience) priorities, for example together with the condition that the priority may apply (e.g., among multiple activities). For example, the WTRU may indicate that UL data transmission is of higher priority than other activities in normal conditions. The WTRU may indicate that if the WTRU has not performed a registration update for certain period of time, registration may be of higher priority than other activities. In another example, if the cell measurement (e.g., RSRP/RSRQ) is below a certain threshold, the cell reselection may be of higher priority than other procedures.

Based on the configuration and/or adapting parameters for example, the WTRU may calculate the energy required for one or multiple activities and/or compare the energy required for one or multiple activities with the available energy. One or more of the following principles may be applied, for example in prioritizing what activity is to be performed. If an activity has an explicit configured priority for example, the activity with a configured priority may be considered before those without explicit priority. If a higher priority activity cannot be completed with the available energy for example, a lower priority activity that can be completed with the available energy may be considered before the higher priority activity. If registration is configured as a higher priority activity than system information update and/or the available energy doesn't support the completion of the registration for example, the WTRU may perform the system information update (e.g., instead). Additionally, or alternatively, after performing the higher priority activity for example, the WTRU may continue to evaluate whether the remaining energy supports another activity in priority order. The WTRU may continue to perform the other activities as long as the remaining energy supports the activities. The WTRU may (e.g., otherwise) go back to dormant/inactive state and/or perform energy harvesting.

There may be a segmented signaling procedure between a WTRU and a network. A signaling procedure may be broken down into two or more segments. A signaling procedure may be broken down into several segments so that the WTRU may complete one segment for each communication window. When the WTRU does not have enough energy to complete a signaling procedure (e.g., registration), for example due to the constraint of the maximum energy the WTRU can harvest or store, the procedure may be broken down into several segments so that the WTRU may complete one segment for each communication window.

A WTRU may perform a negotiation procedure. As part of the negotiation procedure for example, the WTRU may receive information that indicates one or more of that a segmented procedure will be performed, a break-point, and/or that the WTRU and/or an NF will be a controller entity in the negotiation procedure. The break-point may be expressed as a message identifier, a number of messages, and/or an amount of data.

An NF (e.g., an AMF or SMF) may perform a negotiation procedure. As part of the negotiation procedure, the NF may receive information that indicates one or more of that a segmented procedure will be performed, a break-point, and/or if the WTRU and/or the NF will be a controller entity in the negotiation procedure. The break-point may be expressed as a message identifier, a number of messages, and/or an amount of data.

The NF may receive data that is associated with (e.g., part of) the segmented procedure. The NF may receive a break-point indication. The break-point indication may be expressed as an identifier in a message. The WTRU may send the break-point indication after receiving an amount of data. The WTRU may send the break-point indication after receiving a number of messages. The NF may determine that the WTRU is in an IDLE state, for example, based on receiving the break-point indication from the WTRU. The NF may determine that the WTRU has moved out of the IDLE state and/or determined to continue the segmented procedure when the NF receives additional data associated with the segmented procedure from the WTRU.

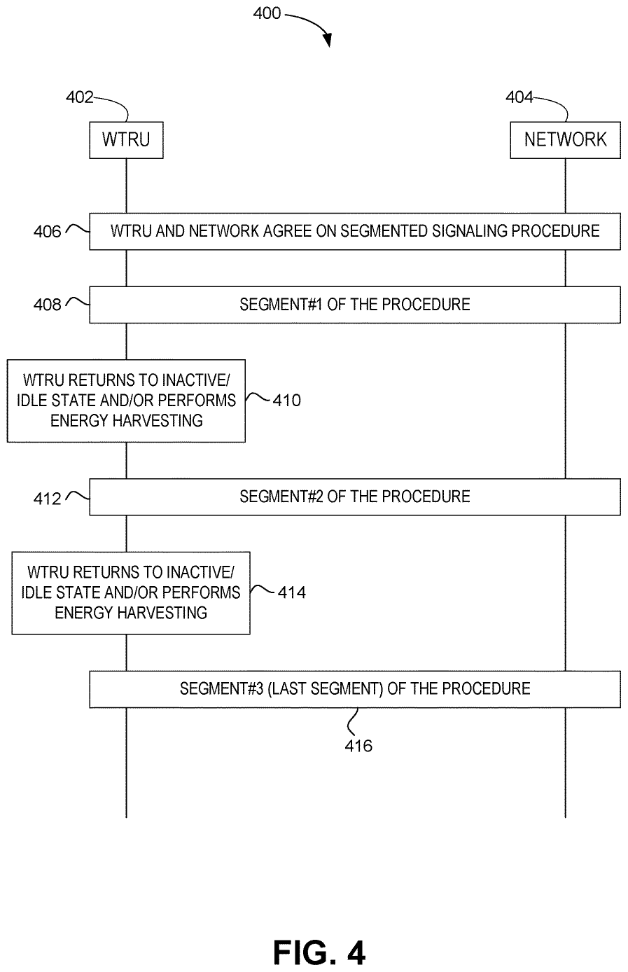

FIG. 4 is an example of a segmented signaling procedure 400. The break-down of the segmented signaling procedure 400 may be controlled by either the WTRU 402 or the network 404. For example, (e.g., either) the WTRU 402 and/or the network 404 may determine a break-point of the segmented signaling procedure 400. The break-point may be referred to as a pause-point of the procedure 400. For example if a signaling procedure comprises 9 messages exchanges, the controller entity (e.g., WTRU 402 or network 404) may determine to pause the procedure after message (x) (e.g., the break-point message) and/or inform the other entity. When the WTRU 402 has harvested enough energy to support signaling exchange again (e.g., at a next communication window) for example, the WTRU 402 may reestablish connection with the network 404 and/or the procedure may continue from Message (x+1). If the network 404 takes the controller role a network function, for example a serving AMF or SMF, may execute the controller role.

The selection of the break-point may be limited due to some message exchanges within a signaling procedure having to be completed within one communication session/window. For example, message exchanges for authentication/authorization purpose, within a registration procedure, may not be breakable (e.g., separated into different segments).

The WTRU 402 may report the WTRU available energy level. The network 404 may calculate and/or estimate the active time and/or amount of data that the WTRU 402 may support with the reported energy level. The network 404 may return the estimated communication budget information and/or other additional information, for example as described herein, to the WTRU 402. The network 404 may utilize intelligent analytics (e.g., provided by NWDAF), for example to help determine the above communication budget information.

The estimated communication budget information may include one or more of an amount of data associated with the data transmission, an amount of time the WTRU 402 can stay in a connected mode, and/or an amount of the one or more transactions. The transaction information associated with a data transmission may include one or more of a reason that the network 404 triggered the WTRU 402 to send the service request, an amount of data associated with the data transmission, an amount of time associated with the data transmission, and/or an amount of the one or more transactions. The WTRU 402 may determine the estimated communication budget information. The communication budget information may include (e.g., an indication of) an energy level of the WTRU 402, for example an available energy level.

At 406, the WTRU 402 and the network 404 may agree on the break-down of the procedure, and/or negotiate which entity takes the role of the controller entity, for example before the WTRU 402 and/or the network 404 start a segmented signaling procedure. The negotiation may occur during the first message (e.g., WTRU to Network message) of the procedure (e.g., registration request, service request, PDU session establishment request, etc.) in which, for example the WTRU 402 may indicate the WTRU's capability of supporting segmented procedure and/or a request to use segmented procedure. The WTRU 402 and/or the network 404 may additionally, or alternatively, propose which entity takes the role of controller entity. In a network response message, the network 404 may indicate to the WTRU 402 whether the network 404 has approved the segmented procedure and/or which entity becomes the controller. The WTRU 402 and the network function may both take the controller role. If the network 404 takes the controller role for example, the WTRU 402 may report the WTRU current communication budget in a (e.g., each) message sent to the network 404. The communication budget information may allow the network 404 to better select the break-points. During the negotiation procedure for example, the WTRU 402 may indicate the break-point to the network 404. The break-point may be identified by a message number or an amount of data. Alternatively, or additionally, the network 404 may indicate the break-point to the WTRU 402.

If the controller entity selects a message (x) as the break-point for example, the controller may include an indication in message (x) that the procedure will temporarily pause after the message. The other non-controller entity may (e.g., still) send a response message (e.g., if that is required). The non-controller entity may (e.g., otherwise) stop sending further messages and/or expecting new messages from the controller entity. In (e.g., both) the controller entity and/or the non-controller entity, timer(s) related to the signaling procedure may be adjusted, for example to take the segmented procedure into account. Reception of the break-point message and/or an indication that a break-point has been reached by the WTRU 402 may trigger the WTRU 402 to move to an IDLE state. Reception of the break-point message and/or an indication that a break-point has been reached by an NF may trigger the NF to consider the WTRU 402 to be in an IDLE state.

At 408, a first segment of the procedure may be performed. For example, the WTRU 402 may receive data that is associated with (e.g., part of) the segmented procedure. The WTRU 402 may determine that the break-point has been reached. For example, the WTRU 402 may receive a break-point indication. The break-point indication may be expressed as an identifier in a message. The WTRU 402 may determine that the break-point has been reached after receiving an amount (e.g., a predetermined and/or threshold amount) of data. The WTRU 402 may determine that the break-point has been reached after receiving a number of messages. At 410, for example, the WTRU 402 may determine to move to an IDLE state when the break-point has been reached. The WTRU 402 may move to the IDLE state, for example, until a predetermined amount of energy is harvested (e.g., after moving to the IDLE state) for communication. Additionally, or alternatively, the WTRU 402 may determine to move to an IDLE state based on receiving the break-point indication. The WTRU 402 may move out of the IDLE state and/or continue the segmented procedure when the WTRU 402 has harvested the predetermined amount of energy (e.g., after moving to the IDLE state).

At 412, a second segment of the procedure may be performed, as discussed herein, for example as similar to at 408. At 414, the WTRU 402 may determine to move to an IDLE state when the break-point has been reached. At 416, a third segment of the procedure may be performed, as discussed herein for example similar to at 408 and/or 412. The WTRU 402 may determine to move to an IDLE state after 416. There may be any number of segments in a procedure.

The segment may additionally, or alternatively, apply to one single message. The WTRU 402 and/or the network 404 may determine to segment a (e.g., long) message into a few segments, for example if the estimated communication budget does not support sending/receiving the message in a single shot (e.g., transmission). If a message is to be segmented for example, the sending entity (e.g., WTRU 402 and/or network function) may allocate a message identifier which. The message identifier may be common to one or more (e.g., all) segments of the same message and/or be associated with consecutive sequence numbers to each segment of the message. The last segment of the message may additionally, or alternatively, be marked so, for example, that the receiving entity understands that one or more (e.g., all) of the segments are available and/or may try to assemble all received segments to a whole message.

What is claimed is:

1. A method implemented by a wireless transmit/receive unit (WTRU), the method comprising:
sending a first message to a network, the first message comprising an indication of estimated communication budget information;
receiving a second message from the network in response to the first message, the second message comprising transaction information associated with a data transmission;
receiving one or more of a control plane message or user plane data associated with one or more transactions;
determining to enter a low power state; and
sending a third message to the network, the third message comprising an indication to continue a transaction that was not completed or an indication to start a transaction that was not started due to an energy level associated with the WTRU.

2. The method of claim 1, wherein the first message further comprises an indication of a trigger, the trigger comprising one or more of expiration of a timer, reception of wake-up signal, reception of a paging indication, reception of a paging message, or a location change.

3. The method of claim 1, wherein the third message comprises an access network message or a service request message that comprises an indication of a transaction identifier.

4. The method of claim 1, further comprising determining whether to send the third message to the network based on the transaction information and the energy level associated with the WTRU.

5. The method of claim 1, wherein determining to enter the low power state comprises determining to enter the low power state based on one or more of the transaction information, an amount of received data, an amount of time that the WTRU has been in a connected mode, or an amount of the one or more transactions.

6. The method of claim 1, wherein the estimated communication budget information comprises one or more of an estimated amount of data the WTRU can receive, an amount of time the WTRU can stay in a connected mode, or an amount of the one or more transactions.

7. The method of claim 1, wherein the transaction information associated with a data transmission comprises one or more of a reason that the network triggered the WTRU to send the service request, an amount of data associated with the data transmission, an amount of time associated with the data transmission, or an amount of the one or more transactions.

8. The method of claim 1, further comprising determining the estimated communication budget information based on the energy level of the WTRU.

9. A wireless transmit/receive unit (WTRU) comprising a processor, the processor configured to:
send a first message to a network, the first message comprising an indication of estimated communication budget information;
receive a second message from the network in response to the first message, the second message comprising transaction information associated with a data transmission;
receive one or more of a control plane message or user plane data associated with one or more transactions;
determine to enter a low power state; and
send a third message to the network, the third message comprising an indication to continue a transaction that was not completed or an indication to start a transaction that was not started due to an energy level associated with the WTRU.

10. The WTRU of claim 9, wherein the first message further comprises an indication of a trigger, the trigger comprising one or more of expiration of a timer, reception of wake-up signal, reception of a paging indication, reception of a paging message, or a location change.

11. The WTRU of claim 9, wherein the third message comprises an access network message or a service request message that comprises an indication of a transaction identifier.

12. The WTRU of claim 9, wherein the processor is further configured to determine whether to send the third message to the network based on the transaction information and the energy level associated with the WTRU.

13. The WTRU of claim 9, wherein the processor configured to determine to enter the low power state comprises the processor being configured to determine to enter the low power state based on one or more of the transaction information, an amount of received data, an amount of time that the WTRU has been in a connected mode, or an amount of the one or more transactions.

14. The WTRU of claim 9, wherein the estimated communication budget information comprises one or more of an estimated amount of data the WTRU can receive, an amount of time the WTRU can stay in a connected mode, or an amount of the one or more transactions.

15. The WTRU of claim 9, wherein the transaction information associated with a data transmission comprises one or more of a reason that the network triggered the WTRU to send the service request, an amount of data associated with the data transmission, an amount of time associated with the data transmission, or an amount of the one or more transactions.

16. The WTRU of claim 9, wherein the processor is further configured to determine the estimated communication budget information based on the energy level of the WTRU.

17. A network entity comprising a processor, the processor configured to:
receive a first message from a wireless transmit/receive unit (WTRU), the first message comprising an indication of estimated communication budget information;
send a second message to the WTRU in response to the first message, the second message comprising transaction information associated with a data transmission;
send one or more of a control plane message or user plane data associated with one or more transactions; and
receive a third message to the network, the third message comprising an indication to continue a transaction that was not completed or an indication to start a transaction that was not started due to an energy level associated with the WTRU.

18. The network entity of claim 17, wherein the first message further comprises an indication of a trigger, the trigger comprising one or more of expiration of a timer, reception of wake-up signal, reception of a paging indication, reception of a paging message, or a location change.

19. The network entity of claim 17, wherein the third message comprises an access network message or a service request message that comprises an indication of a transaction identifier.

20. The network entity of claim 17, wherein the estimated communication budget information comprises one or more of an estimated amount of data the WTRU can receive, an amount of time the WTRU can stay in a connected mode, or an amount of the one or more transactions.
